(19) United States
(12) Patent Application Publication
(10) Pub. No.: US 2010/0303599 A1
(43) Pub. Date: Dec. 2, 2010

(54) HANDLING ROBOT FOR PALLETIZER

(75) Inventor: Eric Bonhomme, Octeville- Sur -Mer (FR)

Correspondence Address: SUGHRUE MION, PLLC, 2100 PENNSYLVANIA AVENUE, N.W., SUITE 800, WASHINGTON, DC, 20037, US

(73) Assignee: SIDEL PARTICIPATIONS, Octeville-Sur-Mer (FR)

(21) Appl. No.: 12/680,487

(22) PCT Filed: Sep. 25, 2008
(86) PCT No.: PCT/FR2008/051714

§ 371 Date: Mar. 26, 2010

(30) Foreign Application Priority Data
Sep. 28, 2007 (FR) 0706788

(51) Int. Cl. B25J 13/00; B25J 18/02

(52) U.S. Cl. 414/788.1

(57) ABSTRACT

According to the invention, the handling robot includes a vertical telescopic mast (11) that comprises: a vertically fixed base (20); and a plurality of sections (21-23) with synchronised movements, said movements being speed- and acceleration-controlled and including a gravity extension movement and a powered retraction movement, the last section (23) bearing a head (13) for gripping the products (3) to be palletised. The robot includes a common driving shaft (30) for moving the different sections (21, 22, 23), wherein said shaft (30) includes wheels (31, 32, 33) having a diameter adapted to the travel of the section (21-23′) they operate, respectively, via transmission members. For the last section (23) bearing the gripping head, the movement transmission is carried out by chains and for the other sections the transmission members between the wheels (31, 32) and the sections thereof (21, 22) consist of belts that wind up on the corresponding wheel. A housing (46) receives and stores the free end of each movement transmission chain, and is made in the form of a block with notches each defining a curved helical path.

### CROSS REFERENCE TO RELATED APPLICATION

This application is a National Stage of International Application No. PCT/FR2008/051714 filed Sep. 25, 2008, claiming priority based on French Patent Application No. 0706788, filed Sep. 28, 2007, the contents of all of which are incorporated herein by reference in their entirety.

### FIELD OF THE INVENTION

The invention relates to palletization facilities, and in particular to an improvement to the handling robot which grasps the products supplied by a conveying device and arranges them on a pallet.

### DESCRIPTION OF THE PRIOR ART

This type of palletization facility, or palletizer, comprises a structure which serves as a framework for supporting the handling robot. This robot is a three- or four-axis robot and is composed of:—a platform which moves on rails arranged on the upper part of said framework, —a vertical mast which is supported and guided by said platform, and, at the extremity of said mast,—a gripping head appropriately equipped to take hold of the products to be palletized.

The gripping head can be pivoting, on the fourth axis, and have suction cups for grasping products on the supply conveyor and then arranging them in the proper orientation on the pallet.

This type of facility is subject to multiple constraints, including the primary constraints related to operator safety and comfort, but also constraints related to product throughput and type, e.g. weight, size, and those related to problems with installing this type of equipment which must be able to fit into existing buildings that may have a very low ceiling.

Robot palletizers have been in existence for a long time, and this problem of space for housing the robot has already been mentioned and resolved as described, for example, in document FR2642059.

### SUMMARY OF THE INVENTION

The present invention proposes a handling robot for a palletizer which provides a response to this type of installation and spacing constraint.

It also provides a response to the other constraints related to the environment, with a decrease in noise, and related to operating safety with, in particular, an original control of the movements of the gripping head which protects against dropping hazards.

The handling robot of the invention also proposes, as described in the document cited above, the use of a telescoping mast for handling crates for palletization. This type of telescoping mast is also described in other documents concerning the art such as, for example, documents JP03241121 and U.S. Pat. No. 5,465,854; these two documents respectively show a manipulating telescoping mast of a back-hoe and a telescoping mast for manipulating an instrument for testing and inspecting various objects.

The handling robot of the invention, which is a three- or four-axis robot for a palletizer, comprises:—a platform which is guided, transversely to the direction in which the products arrive, on beams situated in the upper part of the framework of said palletizer, and—a telescoping vertical mast consisting of: a vertically fixed base which allows limiting the height requirements of said palletizer, said fixed base supported and longitudinally guided on said platform, and several sections of which the last, or central, section supports the head for gripping said products to be palletized, these sections being manipulated by wheels of diameters appropriate for the travel distance of the section to which they are attached, and by means of independent connecting members, said wheels being mounted onto the same common shaft which provides gravitational extension movement and powered retraction movement, said connecting members between said sections and said wheels consisting of at least one transmission chain for said last section and belts for the other sections, said belts winding around their respective wheel.

This arrangement, with a chain which establishes a strong connection between the load and the drive shaft and with belts which accompany the movement of the other sections, allows flexible operation and, above all, a particularly quiet operation of the robot.

Still according to the invention, the last section of the mast is associated with two transmission chains each cooperating with a sprocket wheel, said wheels being placed side by side on the drive shaft, and one of the chains acting as the primary chain for ensuring normal movement of the last section while tension is maintained in the other chain which serves as a retaining and safety device in case of breakage of said primary chain.

In another arrangement of the invention, the tensioning means of the second chain comprises an elastic member placed between a support located on the upper part of the last section and a stop, said stop being arranged at the lower extremity of a rod that extends the chain and passes through an opening in said support which serves as a guide for it.

Still according to the invention, the chains for maneuvering the last section extend from their sprocket wheel between the upper part of said last section and a housing which accepts and stores their free end, said housing being in the form of a block equipped on each face with a curved helical groove which accepts said corresponding free end, these grooves being cut into the lateral faces of said block.

In another arrangement of the invention, the block serving as the housing for the free ends of the two chains is made of thermoplastic material and is in the form of a rotated L, said block partially covering the upper part of each sprocket wheel, acting as a guide for said chains, for about half of the circumference of said sprocket wheels.

Still according to the invention, the robot comprises, in association with one of the sprocket wheels, a safety device comprising a latch which is maneuvered by means of an actuator supplied with compressed air to maintain said hook in the inactive position and with a spring which places this hook in the active position, if needed, during operator intervention on the machine for example.

### BRIEF DESCRIPTION OF THE DRAWINGS

The invention will be further detailed in the following description and the attached drawings, provided as examples, and in which:

FIG. 1 is a schematic elevated view of a palletization facility comprising a robot of the invention with its mast represented in two positions: it is represented with bold lines in the retracted position and represented with thin dotted lines in the completely extended position

FIG. 2 is an enlarged schematic horizontal cross section from 2-2 of the mast which appears in bold lines in FIG. 1

FIG. 3 is an enlarged partial schematic vertical cross section viewed from 3-3 of the mast which appears in bold lines in FIG. 1

FIG. 4 is a partial schematic vertical cross section viewed from 4-4 in FIG. 3

FIG. 5 is an enlarged cross section from 5-5 in FIG. 4, showing the housing in the form of a block, which guides the free ends of the two transmission chains associated with the last section of the mast,

FIG. 6 is a more detailed schematic view of the safety system for locking the notched and sprocketed wheels which maneuver the sections.

### DETAILED DESCRIPTION OF THE INVENTION

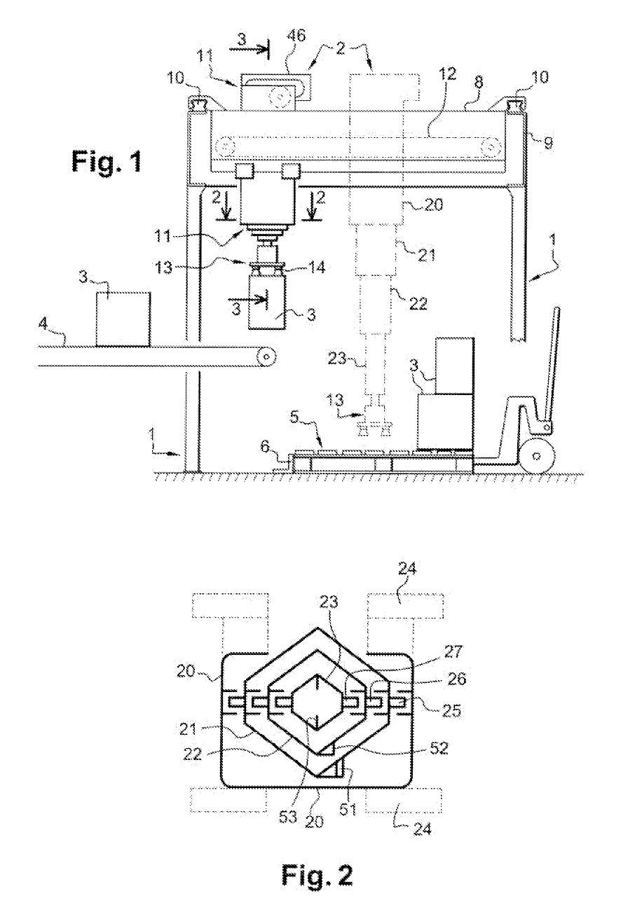

The palletization facility represented in FIG. 1 comprises a structure in parallelepiped form which constitutes the framework 1 of what is more simply called a palletizer.

This framework 1 forms a sort of gantry which is arranged to accept a handling robot 2 with three or four axes, said robot 2 picking up the products 3 supplied by a conveyor 4 and arranging them on a pallet 5 which is positioned within a frame of reference 6 of the facility.

The robot 2 is composed of—an overhead traveling platform 8 which moves along the upper beams 9 of the framework 1 under the effect of appropriate motorized means, guided by means of guide rails 10, and—a vertical mast 11 which is supported and guided by said platform 8 as it moves under the effect of appropriate means such as a motorized belt 12.

The platform 8 moves in a direction which is transverse to the direction in which the products 3 arrive; the mast 11 moves longitudinally, in a direction which is parallel to that of the arrival of said products.

The mast 11 comprises the head 13 which is arranged to allow it to grip products 3. This head may be pivoting, around a vertical axis, in order to align said products in the appropriate position for their placement on the pallet 5, said pivoting axis constituting the fourth axis of the robot 2.

The head 13 is, for example, equipped with a gripping device which is constituted of several suction cups 14.

The movements of the head 13 in the transverse direction and in the longitudinal direction result respectively from movements of the platform 8 relative to the framework 1 and of the mast 11 relative to said platform 8.

The vertical movement of the head 13 is ensured by the mast 11 which, in the context of the invention, is telescoping. This mast 11 is in fact composed of—a base 20 whose vertical position is fixed, and as represented by the thin dotted lines in FIG. 1,—several sections 21 to 23 which extend downwards, under said base.

The base 20 projects slightly above the framework 1 and, considering the fact that it is vertically immobile, it is this that defines the maximum height requirement of the facility, said height requirement practically limited to the height of the framework 1; this allows easy installation of the palletizer in existing buildings.

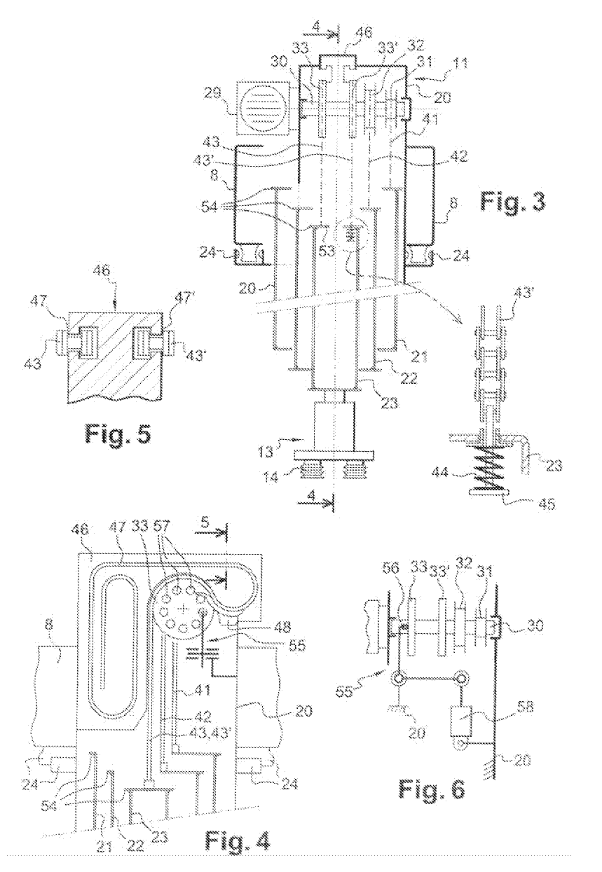

This base 20 is longitudinally guided on the platform 8 by means of guide rails 24, shown in FIG. 3.

In the embodiment detailed in the drawings, the telescoping mast 11 comprises the base 20 into which a first section 21 is guided; this section 21 guides a second section 22 and that section 22 guides the last section 23 which is in the center and which supports the head 13 for gripping the products 3 mentioned above. The sections 21 and 22 act as the connection between the base 20 and the last section 23; this assembly allows having an advantageous vertical travel distance for the gripping head 13.

All these sections 21 to 23 move vertically, beneath the base 20, within the enclosure of the palletizer; their downward movement is due to simple gravity but is controlled, and the upward movement is caused by motorized means.

These upward and downward movements of each section are synchronized and their speed and acceleration are motor-controlled, as detailed below.

FIG. 2 schematically shows a horizontal cross section of the different elements of the mast 11. Starting from the base 20, they are successively:

the first intermediate section 21, which is vertically guided relative to said base by means of a set of guide rails 25 arranged in a longitudinal vertical plane,

the second intermediate section 22, which is guided in the same manner by means of a set of guide rails 26 arranged in the same vertical plane,

the last section 23, which is also guided by a set of guide rails 27 arranged in said vertical plane.

These different sections 21 to 23 all move vertically together and their movements are synchronized by means detailed below. In fact, unlike the common practice, the sections do not move each other by means of travel limit stops.

One will also note that the gripping head 13 is located in the same vertical plane as the guide rails 25, 26, and 27 for the respective sections 21, 22 and 23. This arrangement allows concentrating the lifting force on the central axis of the mast and avoids friction and sticking issues due to overhang of the load which is at the end of the central last section 23.

The synchronized movements of the sections 21 to 23 allow smooth displacement of the head 13, without shocks and abrupt movements, which also eliminate the excessive noise from this type of equipment.

Each section 21 to 23 is connected to a driving member 29 which is common to all said sections. This connection is made by means of wheels which are supported by a single shaft 30 which is the shaft of said driving member 29 and by transmission members such as chains and belts, as represented in FIG. 3.

In this FIG. 3, one can see the base 20 which is supported and guided by the platform 8 by means of guide rails 24, and this base 20 is traversed by the shaft 30 of the driving member 29.

This shaft 30 is arranged transverse to the platform 8 and comprises several wheels:

a first wheel 31 which is connected to the first intermediate section 21 by a belt 41,

a second wheel 32 which is connected to the second intermediate section 22, also by a belt 42,

a third and a fourth wheel 33, 33′, which are identical and connected to the last section 23 by respective transmission chains 43 and 43′.

The diameters of the different wheels 31 to 33 and 33′ are adapted to the vertical travel distance of their respective sections. The diameter of the wheels 33, 33′ is roughly three times that of the first wheel 31, and that of the second wheel 32 is roughly twice that of said first wheel 31.

The belts 41 and 42 are cogged belts whose extremities are respectively anchored on the wheels 31 and 32 and on the sections 21 and 22. They are stored on their respective wheels, meaning that they wind or unwind on the wheel in question according to the movement of said sections.

These belts 41 and 42 are anchored at the sections 21 and 22 by means of respective tabs 51, 52. Said attaching tabs are slightly offset from each other, as represented in FIG. 2.

The wheels 33 and 33′ are sprocket wheels which mesh with the respective transmission chains 43, 43′.

The chain 43 is fixed to the upper part of the section 23 at the tab 53, said tab situated in a median transverse plane which is perpendicular to the plane of the guide rails 25 to 27.

The wheel 33 and its chain 43 are primarily responsible for the motion of the last section 23.

The wheel 33′ and its corresponding chain 43′ constitute a safety device to prevent a risk of breakage in the other chain 43. Tension is simply maintained in the chain 43′, by means of an elastic member 44 as represented separately in more detail; it does not continuously and directly participate in the maneuvering of the last section 23.

The elastic member 44 is placed between a support situated on the upper part of the last section 23 and a stop 45, said stop 45 being situated at the lower extremity of a rod positioned at the extremity of the chain 43′ and which extends said chain by traversing an opening in said support, said support serving as a guide for it.

Purely mechanical stops 54, situated in the upper part of each mobile section, establish a limit to the movement of these different mobile sections in case of necessity.

The chains 43 and 43′ extend from their respective wheels 33 and 33′, on one side down to the section 23 and on the other they are free and the corresponding end is stored in a housing 46.

This housing 46 is in the form of a block of thermoplastic material. It comprises a groove 47, 47′ in each lateral face, which accepts the free ends of the respective chains 43 and 43′, defining a curving helical path for each one.

These grooves 47 and 47′ are cut into the block constituting the housing 46 and are in the form of a T, as represented in FIG. 5. This T shape allows each chain 43, 43′ to slide on its proper wheel and remain centered along the length of its respective groove 47, 47′.

In addition, the nature of the material used a thermoplastic material such as polyethylene, facilitates sliding and avoids the improper meshing as it feeds onto the sprocket wheels 33 and 33′ which can result from sticking phenomena in the links of the chains 43, 43′.

The block that constitutes the housing 46 is arranged perpendicularly to the shaft 29 between the wheels 33 and 33′. This housing 46 is in the form of a rotated L covering the wheels 33 and 33′ and it envelops part of their circumference.

The two chains 43 and 43′ wind around the upper part of the circumference of the respective wheels 33 and 33′; they are covered and guided by means of the housing 46.

As the corresponding chain 43, 43′ leaves its sprocket wheel 33 and 33′, it is directed towards the entry into the respective groove 47, 47′ in the housing 46 by means of a guide 48. Only one guide 48 appears on the drawings and in particular in FIG. 4.

This guide 48 helps the corresponding chain to leave the sprocket wheel; it accompanies and directs the outside edge of the chain 43 towards the housing 46 entrance when the section 23 is lifting and guides it to mesh with the wheel during the inverse movement.

Each chain 43, 43′ follows a curving helical path which first loops on one side of the block, said loop followed by a rectilinear path which passes above the corresponding wheel 33, 33′, before forming, on the other side of said block, a large vertical loop whose height is about a fourth of the travel distance of the outside section.

FIG. 6 shows the details of a safety device which operates in case of emergency to lock the different sections of the mast 11 almost instantaneously, and especially the head 13 for gripping the products 3.

This safety device comprises a latch 55 which cooperates with one of the wheels to stop the shaft 30 and all the other wheels. In the embodiment presented, the latch 55 is in the form of a hook 56 and cooperates with notches 57 in the sprocket wheel 33, said notches 57 being in the form of openings regularly distributed along a circumference situated under the teeth of said wheel, as shown in FIG. 4.

The hook 56 is set in motion automatically by an actuator 58. This actuator, which is pneumatic, maintains the hook 56 in the inactive position when pneumatic pressure is applied, for example, and automatically assumes the active position when there is no pressure, under the effect of an elastic member such as an integrated spring.

The hook 56 can be activated directly by the operator, for example when he needs to perform an intervention on the machine. It can also be activated automatically, in case of an incident at the gripping head 13 such as, for example, an incident in the air supply to the suction cups 14 that carry the product 3.

1. Handling robot of the three or four axis type for a palletizer, comprising: a platform guided to travel transversely to the direction in which the products arrive, on beams situated in the upper part of the framework of said palletizer, and—a telescoping vertical mast comprising: a vertically fixed base which allows limiting the height requirements of said palletizer, said base supported and longitudinally guided on said platform, and several sections of which the last, or central, section supports the head for gripping said products to be palletized, said sections being connected to wheels of different diameters, said diameters of said wheels being adapted to the travel distance of the section to which these respective wheels are attached by means of independent connection members,
wherein said wheels are mounted on the same common shaft which provides gravitational extension movement and powered retraction movement, said connection members between said sections and said wheels consisting of at least one transmission chain for said last section and respective belts for the other sections said belts winding around their respective wheel.

2. Handling robot according to claim 1, wherein the last section of the mast is associated with two transmission chains each cooperating with a respective sprocket wheel, said sprocket wheels placed side by side on the drive shaft and one of the chains acting as the primary chain for ensuring normal movement of the last section while tension is simply maintained in the other chain which serves as a retaining and safety device in case of breakage of said primary chain.

3. Handling robot according to claim 2, wherein the tensioning means for the second chain comprises an elastic member placed between a support located on the upper part of the last section and a stop, said stop being arranged at the lower extremity of a rod that extends said second chain and passes through an opening in said support which serves as a guide for it.

4. Handling robot according to claim 3, wherein the chains for maneuvering the last section extend from their respective sprocket wheel, between the upper part of said last section and a housing which accepts and stores their free end, said housing being in the form of a block equipped with curved helical grooves which accept said free ends.

5. Handling robot according to claim 4, comprising grooves which respectively accept the chains, said grooves being cut into the lateral faces of the block which constitutes said housing.

6. Handling robot according to claim 5, wherein the block acting as a housing for the free ends of the two chains is realized of thermoplastic material and is present in the form of a rotated L, said block partially covering the upper part of each sprocket wheel serving as a guide for about half of their circumference.

7. Handling robot according to claim 2, comprising, in association with one of the sprocket wheels, a safety device comprising a latch in the form of a hook, said latch maneuvered by means of a mechanical actuator, supplied with compressed air to maintain said hook in the inactive position and operating with a spring to place said hook in the active position of locking the wheel in case of need, in particular during operator intervention on the machine.
